(19) United States
(12) Patent Application Publication
(10) Pub. No.: US 2007/0216053 A1
(43) Pub. Date: Sep. 20, 2007

(54) Method of operating extrusion installations for extruding thermoplastics

(76) Inventor: Walter Breyer, Rielasingen-Worblingen (DE)

Correspondence Address: BACHMAN & LAPOINTE, P.C., 900 CHAPEL STREET, SUITE 1201, NEW HAVEN, CT, 06510, US

(21) Appl. No.: 11/717,862

(22) Filed: Mar. 13, 2007

(30) Foreign Application Priority Data
Mar. 15, 2006 (DE) 10 2006 012 297.6

(51) Int. Cl. B29C 47/92; B29C 47/00

(52) U.S. Cl. 264/40.1; 425/461; 425/378.1; 264/40.6; 264/176.1

(57) ABSTRACT

In a method of operating extrusion installations for extruding thermoplastics with an extrusion installation comprising a downstream slot die the temperature of an outlet region of the slot die is controlled over its width and additionally in selectable regions to influence a thickness of a polymer melt.

### BACKGROUND

(1) Field of the Invention

The present invention relates to a method of operating extrusion installations for extruding thermoplastics with an extrusion installation comprising a slot die arranged downstream of the latter, and relates to a slot die for carrying out the method.

(2) Prior Art

Such methods and slot dies are known in various forms and configurations. Extruded polymer material is extruded by means of extruders and delivered by means of heatable slot dies, the liquid extruded polymer melt usually being fed to a polishing stack for further treatment.

Slot dies are understood as meaning sheet dies, flat film dies, etc., which have a die channel and in the outlet region form corresponding lip elements, it being possible for the lip elements to be rigid, flexible or provided with a corresponding adjusting device. All kinds of lip elements are intended to be covered by this.

In sheet production, slot dies in which a restrictor bar is adjusted by means of adjusting motors to set a melt flow over the die width are used. This setting of the thickness of the melt flow is performed manually, which during operation leads to both wastage and non-productive times.

In the production of films, slot dies which operate in the thickness range from approximately 0.1 to 1.0 mm are used. Automatic dies are used for this. In this case, the melt flow is locally altered by a local infeed adjustment of final controlling elements, in particular final controlling pins, in order to alter the die outlet gap locally at a desired point. This automatic, purely mechanical adjustment of the local die gap is performed with a coupling to a thickness measuring device or a bead measurement, in order to carry out closed-loop control.

A disadvantage of this is that a great amount of wastage is produced due to a long reaction time in the setting of the thickness during operation. Since this technology is restricted to thin sheet thicknesses and, due to correspondingly great changes in temperature, including ambient temperature, the melt is influenced too much in terms of its thickness, the thickness of the extruded melt fluctuates during operation.

### SUMMARY OF THE INVENTION

The present invention is based on the object of providing a method of the type mentioned at the beginning and a slot die for carrying out the method by which the thickness of the polymer melt can be altered in an automated manner during operation over the full width at desired local points in a simple and low-cost way. Moreover, it is intended to be possible for the control rates during operation to be increased and the complexity of the device that is required for this to be significantly minimized. Moreover, it is intended to lower the fabrication costs and production costs and to increase the rate of production while minimizing wastage, including in the critical edge regions.

In the case of the present invention, it has proven to be particularly advantageous to heat an outlet region of the slot die locally at desired points. In addition to the conventional heating devices in the die body, additional heating elements are fitted for this purpose in the outlet region. In this case, the heating elements are provided either in one and/or in the other lip element, preferably near the outlet region, at closely spaced intervals over the full width. The heating elements are preferably fitted in the lip elements exchangeably and interchangeably. The lip elements may be formed in a rigid manner and/or as flexible lip elements. They may also have corresponding quick-adjusting devices for the mechanical adjustment of the thickness of the die gap.

It is important that the individual heating elements can be activated, controlled and operated individually or grouped-together in a segmental manner, in order to heat up or control the temperature of specific local regions, considered over the width of the slot die, differently in a specific, closed-loop controllable manner.

By means of the temperature or by means of open-loop and closed-loop control of the outlet temperature directly in the outlet region of the lip elements, the thickness of the polymer melt can be exactly set and controlled in different regions over the width.

Moreover, it is possible that, by introducing the heating elements into the at least one lip element, the outer form and shape of the lip element can be made narrower, so that a cross-sectional geometry of the outlet region of the slot die can also be adapted to a geometry of the first two rolls of a polishing stack arranged downstream of the slot die.

In this way, the outlet region of the slot die can be moved closer into a roll nip between two adjacent rolls of the polishing stack, so that a distance between the outlet region of the slot die and a center of the roll nip of the first two rolls of the polishing stack is minimized. In this way, the polymer melt is not exposed to any strong ambient influences and temperatures, but arrives in the polishing stack without being exposed to a great thermal influence from outside, and in this way can be processed more homogeneously into films and sheets.

Heating cartridges or similar electrically operated heating elements may be used as heating elements.

It is also intended to consider having appropriate liquid heated media flow through channels or the like in such a way that individual regions over the width of the lip elements can be separately activated, and consequently different regions over the width of the slot die can be controlled in their temperature individually or segmentally. This is likewise intended to be within the scope of the present invention.

It has also proven to be advantageous in the case of the present invention that the individual heating elements, spaced apart at close intervals to one another, are arranged over the full width, and that they are provided in one and/or the other lip element.

In this case, said heating elements may be re-releasably and exchangeably fitted by means of corresponding receiving bores, the heating elements being fitted in the lip element as close as possible to the die channel.

This not only allows a homogeneous polymer melt of a homogeneous thickness to be set during operation, but also allows small constrictions of the films in the edge regions to be ensured. As a result, a more effective useful width with little “nick in” is ensured.

Furthermore, by fitting the individual elements of the slot die in such a way, a die which is not subject to bending is obtained. Furthermore, a simple design of the die body is obtained, without mechanically complex components being required for this.

In this way, the design of the die body itself, in particular the outlet region, is also possible much more freely and can be adapted to the corresponding geometries of pairs of rolls of a polishing stack arranged downstream of the slot die.

The local, differing and individually adjustable and controllable temperature control of the one and/or other lip element in the outlet region, considered over the width, allows very rapid closed-loop control of the temperature of the individual heating elements to be obtained during operation by means of corresponding thickness and/or bead measurement, in order to control or set the thickness of the emerging polymer melt locally by means of the temperature setting. In this case it is possible to dispense with corresponding conventional mechanical adjusting devices, which is also of advantage for bending behavior of the slot die.

### BRIEF DESCRIPTION OF THE DRAWINGS

Further advantages, features and details of the invention emerge from the following description of preferred exemplary embodiments and on the basis of the drawing, in which:

FIG. 1 shows a schematically represented side view of a conventional slot die, arranged over the two first rolls of a polishing stack, only indicated here;

FIG. 2 shows a schematically represented side view of a slot die according to the invention for extruding thermoplastics, with an adapted geometry for moving between a roll nip of a polishing stack;

FIG. 3a shows a schematically represented side view of a slot die with heating elements fitted according to the invention in the upper and lower lip elements;

FIG. 3b shows a schematically represented side view of a further exemplary embodiment of the slot die with heating elements fitted in the lower lip element;

FIG. 3c shows a schematically represented side view of a further exemplary embodiment of a further slot die with heating elements fitted according to the invention;

FIG. 4 shows a schematically represented perspective side view of a slot die according to FIG. 3a;

FIG. 5a shows a schematically represented plan view of a slot die according to FIG. 3a;

FIG. 5b shows a schematically represented plan view of a further embodiment of the slot die according to FIG. 3a.

### DETAILED DESCRIPTION OF THE PREFERRED EMBODIMENT(S)

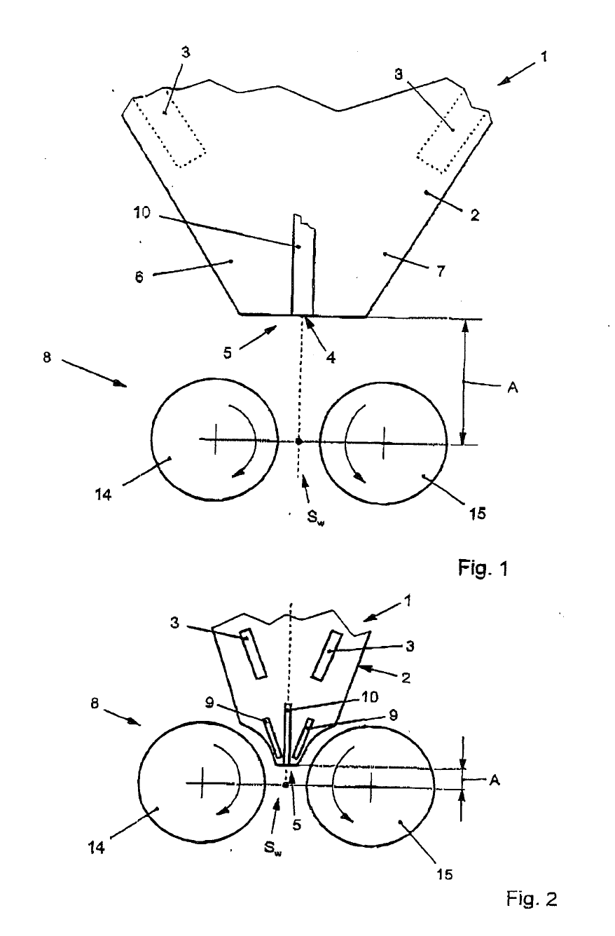

According to FIG. 1, a conventional slot die 1 has a die body 2, which can be heated by means of conventional heating devices 3 for delivering extruded polymer material from extrusion installations out of a die gap 4.

In this case, the die body 2, in particular in an outlet region 5 and a die channel 10, is subdivided into lip elements 6, 7, it being possible for the lip elements 6, 7 to be formed as rigid and/or flexible lip elements 6, 7.

In this case, the lip elements 6, 7 or only one lip element 6 or 7 may have adjusting devices (not represented any more specifically here), such as “fast-gap” adjusting devices or the like, in order to set an adjustment of the die gap in terms of its thickness automatically or mechanically. This adjusting device serves for a rapid adjustment of the thickness of the outlet region of the die element.

A disadvantage of the conventional slot die is that the actual influencing of the thickness of the extruded polymer melt merely takes place mechanically by means of the adjustment of the die gap 4 in individual regions.

Moreover, between the outlet region 5 and a polishing stack 8, only indicated here in FIG. 1, with rolls 14, 15, the polymer melt, which is conducted into a roll nip S_{w}, cools, having the effect that corresponding, possibly different, temperature changes of the polymer melt undesirably occur.

Between a center of the roll nip S_{w} and the actual outlet region 5 of the slot die 1 there is formed a distance A, which is conventionally chosen to be large because of the form of the slot die 1.

Because however of correspondingly massively formed die bodies 2, which have corresponding heating devices 3 to heat the entire die body 2 to liquefy the polymer melt, it is not possible to choose a small distance A between the outlet region 5 of the die body 2 and the center of the roll nip S_{w}.

In the case of the present invention, it has therefore proven to be particularly advantageous, as shown in the exemplary embodiment of the present invention according to FIG. 2, to fit in the outlet region 5 additional heating elements 9 into the die body 2 of a slot die 1 according to the invention, in addition to the conventional heating devices 3.

The heating elements 9 are located in the front region of the lip elements 6, 7 and are preferably arranged or fitted over the full width of the slot die 1, in particular of the lip elements 6, 7, spaced slightly apart next to one another.

The heating elements 9 preferably heat an inner region of the die gap 4 near the outlet region 5.

In this case, the heating elements 9 may be actuated or controlled individually, or grouped-together in a number of segments, in order to set a specific temperature.

In this case, furthermore, it is intended to be within the scope of the present invention that the individual heating elements are arranged either only in one lip element 6 or only in the other lip element 7 or in both lip elements 6, 7, preferably in the outlet region 5.

The activation of the heating elements 9 individually or segmentally allows quite specific selectable regions, considered over the width of the slot die 1, in the outlet region 5 to be controlled differently in their temperature during operation.

The differing temperature control of the polymer melt in the outlet region 5 allows the setting of the melt flow to be influenced by altering the die zone temperature, and consequently the thickness of the polymer melt to be influenced.

In this case, it has also proven to be particularly advantageous in the case of the present invention that, for an optimized die setting, the temperature can be internally set differently in different regions or segments over the full width in the outlet region 5.

As a result, the melt flow can be set or influenced as accurately as desired, comparable with conventional flexible lips, during operation by means of the corresponding heating elements 9 that are additionally fitted on the lip elements 6 and/or 7.

As a result, automation of the bead setting can also be optimized by subsequent connection to a thickness measuring system or to a bead measuring system.

The additional fitting of the heating elements 9 in the outlet region of the lip elements 6 and/or 7 allows the overall geometry of the die body 2 in the outlet region 5 to be altered, so that the slot die 1 can be brought up closer to a roll nip S_{w} of a polishing stack 8, between two rolls 14, 15, as is indicated in FIG. 2.

As a result, a distance A between the center of the roll nip S_{w} and the outlet region 5 of the slot die 1 is significantly reduced, which greatly minimizes the bead formation, and an undesired, non-uniform and uncontrolled cooling or differing cooling behavior of the polymer melt due for example to ambient temperature.

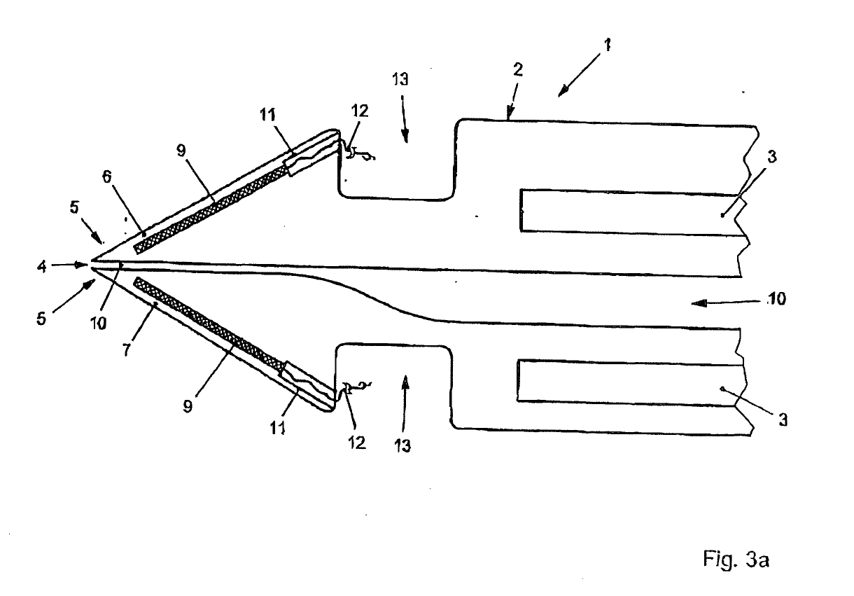

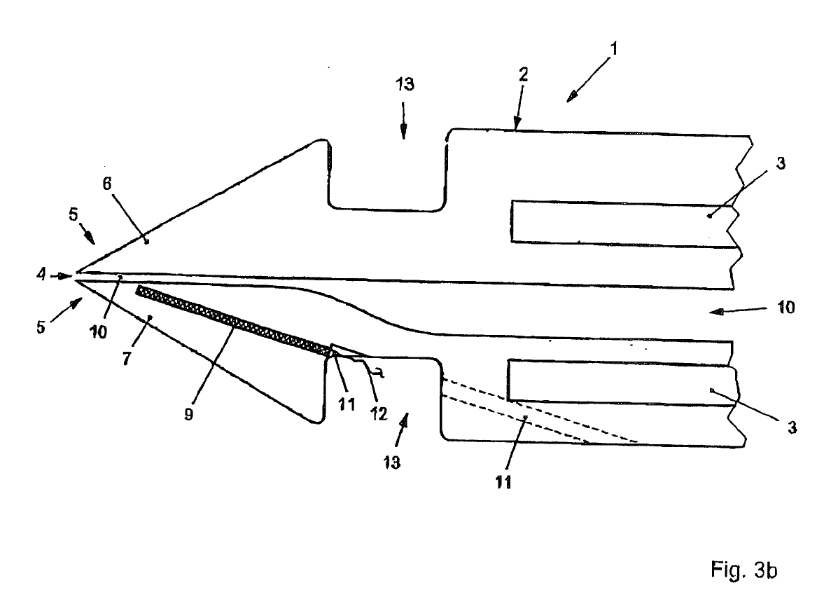

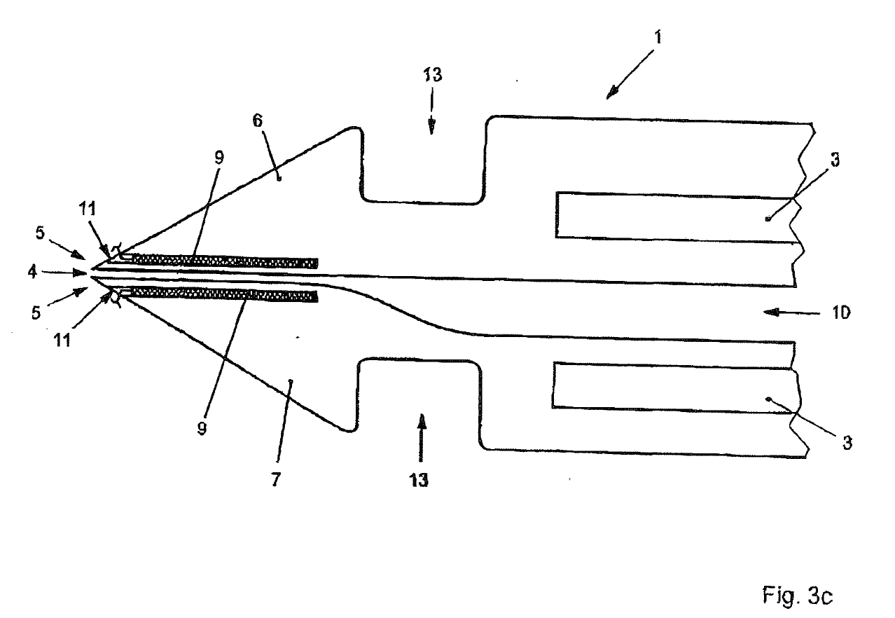

In the exemplary embodiment of the present invention according to FIG. 3a, a side view of a further embodiment of a slot die 1 is schematically presented, in which die the corresponding heating elements 9 are preferably fitted in the respective lip elements 6, 7 in corresponding receiving bores 11 in the outlet region 5.

By means of corresponding electrical connecting lines 12, the heating elements 9, which are spaced slightly apart from one another over the full width of the slot die 1, can be individually or segmentally fitted, activated and supplied with power for heating the lip elements 6, 7.

In this way, differing temperature control of the die channel 10 can be set over the full width in the outlet region 5, so that the melt flow can be influenced, and consequently the setting of the thickness of the extruded polymer melt can be influenced, by the differing temperature control, considered over the width of the slot die 1.

The conventional heating devices 3 remain conventionally as before in the die body 2. The only difference is that the additional heating elements 9 are additionally fitted in the lip elements 6, 7 close by in the outlet region 5.

In the exemplary embodiment according to FIG. 3b, a further slot die 1 is schematically presented, in which die a number of heating elements 9 are merely fitted in one of the two lip elements 6 or 7, with preference slightly spaced apart over the full width. These are operated in the way described above.

A further difference from FIG. 3a is that the heating elements 9 with their receiving bores 11 are fitted as flat as possible at a very acute angle in the lip element 7, in order to transfer heat to the die channel 10 as close as possible to the inside.

With preference, the heating elements 9 are fitted into the lip elements 6, 7 by means of the receiving bores 11, starting from a receiving groove 13 for fitting conventional adjusting devices, etc.

To make it possible for the heating elements 9, which may also be formed as cartridges, to be fitted as flat as possible, it is also conceivable to provide corresponding additional receiving bores 11 in the die body 2 as additional insertion aids.

In the exemplary embodiment according to FIG. 3c, a further slot die 1 is presented, in the case of which die the heating elements 9 may be fitted as closely as possible in at least one lip element 6 and/or 7, preferably over the full width of the slot die 1, slightly spaced apart parallel to one another, virtually parallel to the die channel 10.

In this case, the heating elements 9 may also be fitted from the front, or from the outlet region 5, into the respective lip element 6, 7 via the receiving bore 11. This is likewise also intended to be within the scope of the present invention.

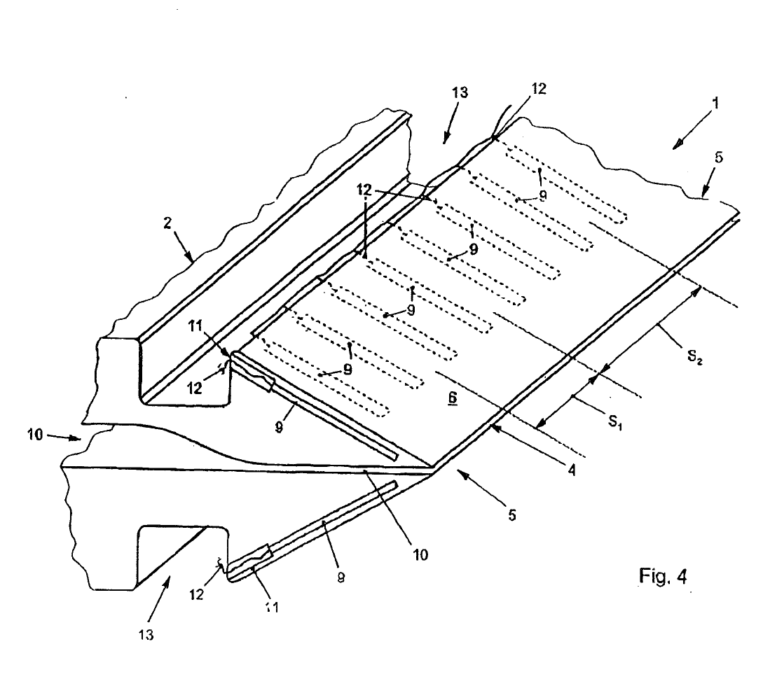

In the exemplary embodiment of the present invention according to FIG. 4, a perspective view of the slot die 1 is presented, in the case of which die the heating elements 9 are fitted in the respective lip elements 6, 7 in a way similar to that according to the exemplary embodiment as shown in FIG. 3a, spaced apart at close intervals respectively parallel to one another.

In this case, the individual heating elements 9 can be individually activated or operated differently or in selectable segments S₁, S₂ by means of the respective connecting lines 12.

In this way, specific regions or segments over the width of the slot die 1 can be individually differently controlled in their temperature or operated.

In this way, a region up to approximately 150 mm, starting from the outlet region 5, of the lip elements 6 and/or 7, in particular in the die channel 10, can be controlled in its temperature differently over the full width in a closed-loop controllable manner, in order to permanently influence and alter a thickness of the emerging extruded polymer melt during operation.

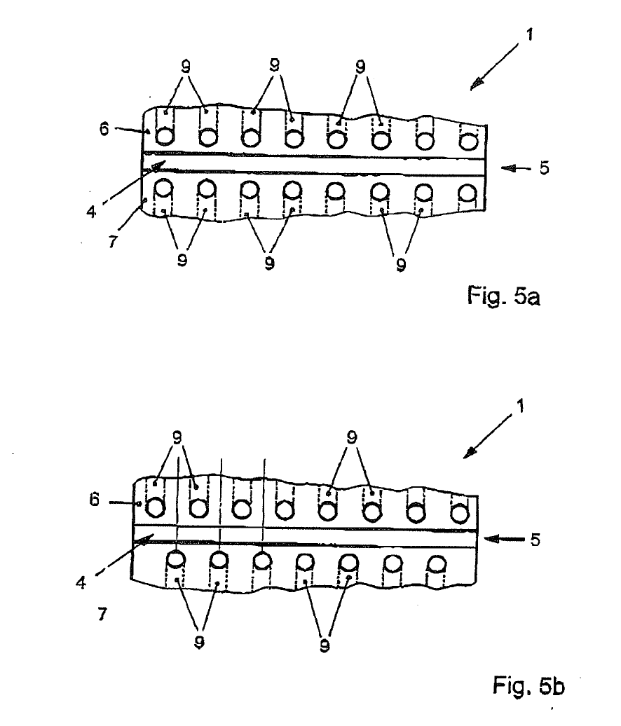

In FIGS. 5a and 5b, respectively corresponding slot dies 1 are presented, the heating elements 9 being respectively fitted such that they are spaced apart from one another in the lip elements 6, 7 of said dies.

In this case, in the exemplary embodiment according to FIG. 5a, the heating elements 9 in the lip element 6 are in line with the heating elements 9 of the lip element 7 lying thereunder in the slot die 1.

In the exemplary embodiment of the present invention according to FIG. 5b, the heating elements 9 of the lip element 6 are arranged offset in relation to the heating elements 9 of the lip element 7. This is likewise intended to be within the scope of the present invention. As a result, still finer influencing, at smaller intervals, of the thickness of the melt can be performed during operation.

What is claimed:

1. Method of operating extrusion installations for extruding thermoplastics with an extrusion installation comprising arranging a slot die downstream of the latter, and controlling an outlet region of the slot die in its temperature in selectable regions over its width to influence a thickness of a polymer melt.

2. Method according to claim 1, wherein said controlling step comprises controlling at least one lip element in its temperature individually, and/or subdivided into regions, over a full width of the slot die, in order to alter the thickness of the emerging polymer melt in a closed-loop controllable manner in certain regions during operation.

3. Method according to claim 1, wherein said controlling step comprises differently controlling at least one region of the slot die in its temperature in a closed-loop controllable manner.

4. Method according to claim 1, further comprising wherein said controlling step comprises influencing the temperature by heating the slot die directly in the outlet region in the region of an outlet opening, in at least one lip element individually or in certain regions in a closed-loop controllable manner, over a full width, to influence the thickness of an emerging polymer melt.

5. Method according to claim 1, wherein said controlling step comprises controlling the temperature of the outlet region of at least one lip element of the slot die, on at least one side by correspondingly provided heating elements.

6. Method according to claim 1, wherein said controlling step comprises controlling the temperature of at least one lip element individually or segmentally over a full outlet width of the slot die, near the outlet region, to influence the thickness of an emerging polymer melt.

7. Method according to claim 1, further comprising geometrically adopting lip elements in the outlet region in such a way that said outlet region is moved between rolls of a downstream polishing stack, close to a roll nip (S_{w}).

8. Method according to claim 1, wherein said controlling step comprises controlling the slot die, in at least one lip element in its temperature in a heating region of up to approximately 100 to 150 mm in width, starting from an outlet opening, over a full width.

9. Method according to claim 1, further comprising adopting the geometry of the slot die in the outlet region approximately to the geometry of two adjacent rolls of a polishing stack, and moving the outlet region of the slot die closer between a roll nip (S_{w}) of the two adjacent rolls of the polishing stack, and performing a local closed-loop temperature control of individual heating elements or segmentally grouped-together heating elements thickness- or bead-dependently during operation by permanent thickness and/or bead measurement of an emerging polymer melt before the polymer melt enters the polishing stack or after the polymer melt emerges from the polishing stack.

10. Slot die for extruding thermoplastics from an extrusion installation, wherein a polymer melt is extrudable out of a die gap of adjacent lip elements and a die body being heatable, said slot die having near an outlet region, at least one of said lip elements being controlled in a closed-loop controllable manner.

11. Slot die according to claim 10, further comprising a plurality of heating elements assigned to the outlet region, and the at least one lip element over a full width.

12. Slot die according to claim 11, wherein the plurality of heating elements can be activated individually or segmentally over the full width, in order to control the temperature of individual regions or individual segments (S₁, S₂) and regions of the outlet region in an open-loop or closed-loop controllable manner during operation.

13. Slot die according to claim 10, wherein the outlet region can be controlled in its temperature internally on at least one side over a full outlet width in small or segmental regions.

14. Slot die according to claim 11, wherein the plurality of heating elements are fitted in a cartridge-like and exchangeable manner in at least one of said lip elements, over the full width, near the outlet region.

15. Slot die according to claim 10, wherein at least one of said heating elements can be activated in a segmentally closed-loop controllable manner, in order to control the temperature of individual regions or larger regions near the outlet region of the lip elements on a die channel side.

16. Slot die according to claim 10, further comprising a geometry of the die body in the outlet region of the lip elements is adaptable to a geometry of two rolls of a polishing stack following downstream of the outlet region.

17. Slot die according to claim 16, further comprising adaptation of an outlet geometry of the outlet region of the lip elements allows the die body to be moved deeper into a roll nip (S_{w}) of the two rolls of the polishing stack.

18. Slot die according to claim 11, wherein each of the heating elements is formed so that the heating elements can be electrically operated and activated as heating cartridges, and are fitted in a front outlet region of the lip elements next to one another over a full width.

19. Slot die according to claim 11, wherein the heating elements are arranged over a full width in at least one of the lip elements and can be individually or segmentally controlled in a closed-loop manner, controlled in their temperature and activated to influence a thickness of an emerging polymer melt.

20. Slot die according to claim 11, further comprising an arrangement of a number of the heating elements next to one another in the lip elements with the heating elements of the two lip elements arranged lying opposite, one above the other or offset in relation to one another, in the two oppositely lying lip elements.

21. Slot die according to claim 11, further comprising a local temperature control of individual heating elements or segmentally grouped-together heating elements being performed thickness- or bead-dependently during operation by permanent thickness and/or bead measurement of the emerging polymer melt before the melt enters the polishing stack or after the melt emerges from the polishing stack.
